(19) United States
(12) Patent Application Publication
(10) Pub. No.: US 2011/0051583 A1
(43) Pub. Date: Mar. 3, 2011

(54) EQUALIZATION FILTER DEVICE, TAP COEFFICIENT UPDATING METHOD, AND REPRODUCTION APPARATUS

(75) Inventor: Mitsugu Imai, Kanagawa (JP)

(73) Assignee: Sony Corporation, Tokyo (JP)

(21) Appl. No.: 12/858,523

(22) Filed: Aug. 18, 2010

(30) Foreign Application Priority Data
Aug. 26, 2009 (JP) JP2009-195133

(51) Int. Cl. H04L 27/01; G11B 7/00

(52) U.S. Cl. 369/59.11; 375/232; G9B/7

(57) ABSTRACT

An equalization filter device includes: an equalization filtering section which has a digital filter and which performs equalization processing on an input signal and updates tap coefficients, which are set for multipliers provided in the digital filter, according to an error between an equalization signal generated by the equalization processing and a target signal; and a tap coefficient holding section which holds the tap coefficients, which are set for the multipliers, in a sequential manner at a necessary timing, wherein the equalization filtering section starts tap coefficient updating calculation processing using the tap coefficients, which are held in the tap coefficient holding section, at an end timing of an abnormal section of the input signal specified on the basis of an abnormal detection result regarding the input signal.

### BACKGROUND OF THE INVENTION

1. Field of the Invention

The present invention relates to an equalization filter device, which has a digital filter and performs equalization processing on an input signal, and a tap coefficient updating method.

In addition, the present invention relates to a reproduction apparatus which reproduces a signal recorded in an optical recording medium.

2. Description of the Related Art

As optical recording media in which a recorded signal is reproduced by irradiation of light, so-called high recording density optical discs, such as BD (Blu-ray Disc: registered trademark), have come into wide use.

In such a high recording density optical disc, PRML (Partial Response Maximum Likelihood) decoding may be performed to reproduce the recorded information.

Moreover, in a reproduction system which performs PRML decoding, so-called adaptive equalization processing may be performed on a reproduction signal in order to absorb a variation in the frequency characteristic of a reproduction signal caused by the characteristics, recording quality, and the like of an optical pickup. Specifically, equalization processing of a reproduction signal is performed using a replica signal, which is obtained by weighting addition of a PR characteristic coefficient (for example, (1, 2, 2, 1)) corresponding to the reproduction system to a bit detection result (channel bit series) of a Viterbi decoder, as a target signal.

FIG. 7 shows a specific example of the configuration for realizing the above-described adaptive equalization processing.

First, as a general equalizer used for adaptive equalization processing, an LMS TVF (Least Mean Square Transversal Filter) is widely known. In FIG. 7, an adaptive equalizer 50 is an equalizer having a configuration as the LMS TVF. Specifically, the adaptive equalizer 50 includes an FIR (Finite Impulse Response) filter 50a and a tap coefficient calculating section 66. In this case, a delay circuit 63, a replica generating section 64, and a subtracter 65 are provided as a configuration for calculating an equalization error on the basis of decoded data DT, which is a decoding result (binarization result) of a Viterbi decoder 51, and an equalization signal yk output from the FIR filter 50a.

A reproduction signal DS obtained by digital sampling of a reproduction signal from an optical disc is input to the FIR filter 50a. As shown in FIG. 7, in the FIR filter 50a, four delay circuits 60-1 to 60-4 are inserted in series on the input line of the reproduction signal DS, and a total of five multipliers 61 are also provided. These are a multiplier 61-0 to which the reproduction signal DS input to the delay circuit 60-1 is branch-input, a multiplier 61-1 to which the reproduction signal DS input to the delay circuit 60-2 through the delay circuit 60-1 is branch-input, a multiplier 61-2 to which the reproduction signal DS input to the delay circuit 60-3 through the delay circuit 60-2 is branch-input, a multiplier 61-3 to which the reproduction signal DS input to the delay circuit 60-4 through the delay circuit 60-3 is branch-input, and a multiplier 61-4 to which the reproduction signal DS is input through the delay circuit 60-4. That is, this is an FIR filter corresponding to “the number of taps=5”.

Outputs of the multipliers 61 (61-0 to 61-4) are added by an adder 62, and the addition result of the adder 62 is output as the equalization signal yk.

The equalization signal yk, which is an output of the FIR filter 50a, is supplied to the Viterbi decoder 51 as an output of the adaptive equalizer 50 and is also supplied to the subtracter 65 through the delay circuit 63.

The replica generating section 64 generates a replica signal by weighting addition of a PR characteristic coefficient (for example, (1, 2, 2, 1)) set beforehand to the decoded data DT supplied from the Viterbi decoder 51. That is, a bit series as a decoding result is converted into a partial response series. As a result, a target signal as an equalization target of the adaptive equalizer 50 is acquired. The target signal as the replica signal generated by the replica generating section 64 is supplied to the subtracter 65.

The subtracter 65 calculates an equalization error by subtracting the equalization signal yk, which is supplied through the delay circuit 63, from the target signal generated by the replica generating section 64.

Moreover, for clarity, the delay circuit 63 is provided for timing synchronization between the target signal and the equalization signal yk and serves to delay the equalization signal yk by the time taken for Viterbi decoding processing.

The tap coefficient calculating section 66 calculates (updates) a tap coefficient of the multipliers 61 (61-0 to 61-4) using a so-called least square method (LMS). The tap coefficient calculated in this way is set for each of the multipliers 61-0 to 61-4.

As is well known, the convergence of a tap coefficient in the LMS takes time because of the nature of the LMS. Accordingly, if a convergence time is not enough, the reproduction performance (reproduction capability) is reduced.

In the LMS, selection of the initial value of a tap coefficient is important. If the initial value of the LMS largely deviates from the original convergence solution, time corresponding to the deviation becomes necessary for the convergence. Moreover, if the initial value is very different from the original solution, oscillation occurs or converging on a different solution from the original solution occurs. That is, the reproduction capability is significantly degraded.

Therefore, in a known optical disc reproduction system, degradation of the reproduction capability is prevented or the convergence time is shortened (in practice, however, there is a limitation on shortening the convergence time due to characteristic variation of optical discs) by providing an initial value of a tap coefficient suitable for the characteristics of an optical pickup or suchlike.

In addition, the convergence of the LMS is not only influenced by the above-described selection of the initial value of a coefficient but also naturally influenced by an input signal. That is, the LMS exhibits the original performance when a normal input signal is given. Regarding an abnormal signal, a tap coefficient is updated to an erroneous value. As a specific example, there is a case where an abnormal reproduction signal is input due to the influence of a so-called defect, for example, by adhesion of fingerprints to an optical disc or damage done to the optical disc. In this case, the tap coefficient may be updated to a coefficient which is very different from the original solution.

Once the tap coefficient is updated to an erroneous coefficient as described above, even if the reproduction signal passes through the defect section and returns to the normal condition, a time for convergence on the correct solution is necessary for awhile after the return to the normal condition. As a result, it is difficult to perform the reproduction based on the original performance in the period.

In view of this point, there is a known optical disc reproduction system which holds a set coefficient in a defect section as a set coefficient at the point of time of defect detection. That is, processing of updating the LMS in a defect section is not performed, and a tap coefficient in a defect detecting section is held as a coefficient set at the point of time of defect detection.

In addition, there is also a method in which, after defect passing, a coefficient is made to return to the initial value and then coefficient updating processing is resumed.

### SUMMARY OF THE INVENTION

Here, FIG. 8 is a timing chart for explaining the former method (that is, a method of holding a coefficient in a defect section) described above, and shows transitions of a reproduction signal waveform, a defect detection signal, and a set coefficient.

First, as is also apparent from FIG. 8, a corresponding time lag occurs in a defect detection result. Accordingly, a certain level of deviation occurs between start/end timing of an actual defect section and start/end timing of a defect section indicated by the defect detection signal.

For this reason, even if a set coefficient when a defect has been detected is held, there is a high possibility that the coefficient at the point of time was already influenced by the defect. That is, as can also be understood from this, in case of adopting the former method described above, that is, a method of holding a set coefficient at the point of time of defect detection and resuming updating calculation processing from the held coefficient after defect passing, a possibility that an inappropriate coefficient setting state will be obtained after the defect passing (that is, a possibility that updating calculation processing from an erroneous coefficient will be resumed) still remains.

From this, it is difficult to say that the former method is a sufficient measure, in terms of preventing a lowering of the reproduction performance after defect passing.

Moreover, in the latter method described above, that is, in a method of resuming coefficient updating processing from the initial value after defect passing, it is possible to prevent the occurrence of an erroneous operation after the defect passing. However, since the updating calculation processing is performed again from the initial state, the latter method is the same as the former method in the sense that reproduction based on the original performance is difficult to perform after defect passing. For this reason, it is also difficult to say that the latter method is reliable as a measure for preventing lowering of the reproduction performance after defect passing.

According to an embodiment of the present invention, there is provided an equalization filter device including an equalization filtering section which has a digital filter and which performs equalization processing on an input signal and updates tap coefficients, which are set for multipliers provided in the digital filter, according to an error between an equalization signal generated by the equalization processing and a target signal.

In addition, the equalization filtering section starts tap coefficient updating calculation processing using the tap coefficients, which are held in the tap coefficient holding section, at an end timing of an abnormal section of the input signal specified on the basis of an abnormal detection result regarding the input signal.

Furthermore, according to another embodiment of the present invention, there is provided a reproduction apparatus including an optical head section which acquires a reproduction signal of a signal recorded in an optical recording medium by irradiation of a laser beam onto the optical recording medium and reception of the reflected light.

In addition, the reproduction apparatus includes an equalization filtering section which has a digital filter and which performs equalization processing on the reproduction signal and updates tap coefficients, which are set for multipliers provided in the digital filter, according to an error between an equalization signal generated by the equalization processing and a target signal.

In addition, the reproduction apparatus includes a tap coefficient holding section which holds the tap coefficients, which are set for the multipliers, in a sequential manner at a necessary timing.

In addition, the reproduction apparatus includes a defect detecting section which detects a defect in the reproduction signal.

In addition, the equalization filtering section starts tap coefficient updating calculation processing using the tap coefficients, which are held in the tap coefficient holding section, at an end timing of a defect section of the reproduction signal specified on the basis of a defect detection result of the defect detecting section.

Thus, according to the embodiments of the present invention, tap coefficients set for multipliers are sequentially held at the necessary timing. As a result, a tap coefficient as a converging value when the input signal is in a normal condition can be held.

Moreover, according to the embodiments of the present invention, the tap coefficient updating calculation processing using the tap coefficient held as described above is started at the end timing of the abnormal section of the input signal. As a result, the tap coefficient updating calculation processing after the abnormal condition is resolved can be resumed using a correct tap coefficient corresponding to that in the normal condition.

In this way, according to the embodiments of the present invention, the tap coefficient updating calculation processing after the abnormal condition is resolved can be resumed using a correct tap coefficient corresponding to that in the normal condition.

Accordingly, it is possible to effectively prevent the occurrence of a situation where the reproduction capability is reduced after an abnormal condition is resolved. That is, stability in the face of an abnormal condition, such as a defect, can be improved.

### BRIEF DESCRIPTION OF THE DRAWINGS

FIG. 1 is a view showing the internal configuration of a reproduction apparatus as an embodiment;

FIG. 2 is a view showing the internal configuration of an adaptive equalizer (equalization filter device as an embodiment) provided in the reproduction apparatus as a first embodiment;

FIG. 3 is a view for explaining a tap coefficient updating method as the first embodiment;

FIG. 4 is a view for explaining a tap coefficient updating method as a second embodiment;

FIG. 5 is a view for explaining the configuration for realizing the tap coefficient updating method as the second embodiment;

FIGS. 6A and 6B are views for explaining a modification of coefficient hold timing;

FIG. 7 is a view for explaining the configuration of an adaptive equalizer when applied to a read channel using PRML; and

FIG. 8 is a timing chart for explaining a known coefficient hold function.

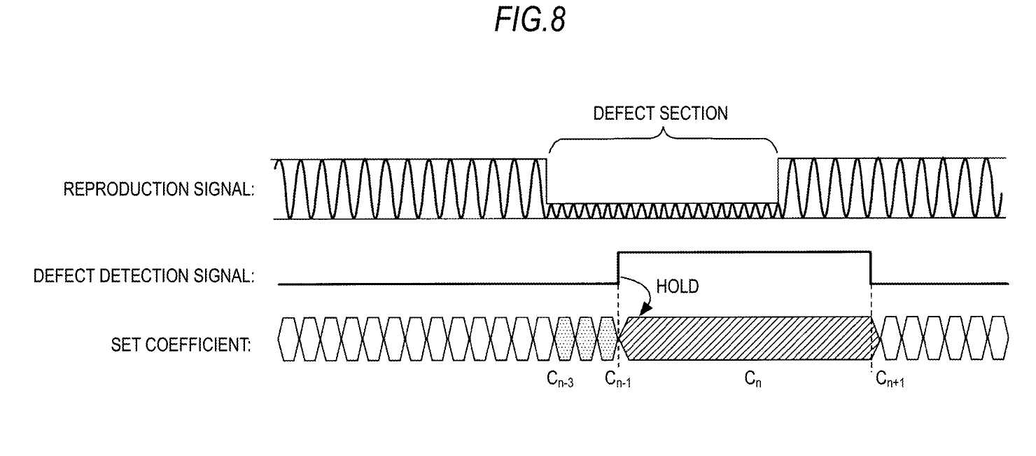

### DESCRIPTION OF THE PREFERRED EMBODIMENTS

Hereinafter, modes for carrying out the present invention (hereinafter, referred to as embodiments) will be described. The explanation will be made in the following order.

<1. First embodiment>

[1-1. Internal configuration of a reproduction apparatus]

[1-2. Internal configuration of an adaptive equalizer]

[1-3. Explanation regarding an operation]

<2. Second embodiment>

<3. Modifications>

### 1. First Embodiment

### [1-1. Internal Configuration of a Reproduction Apparatus]

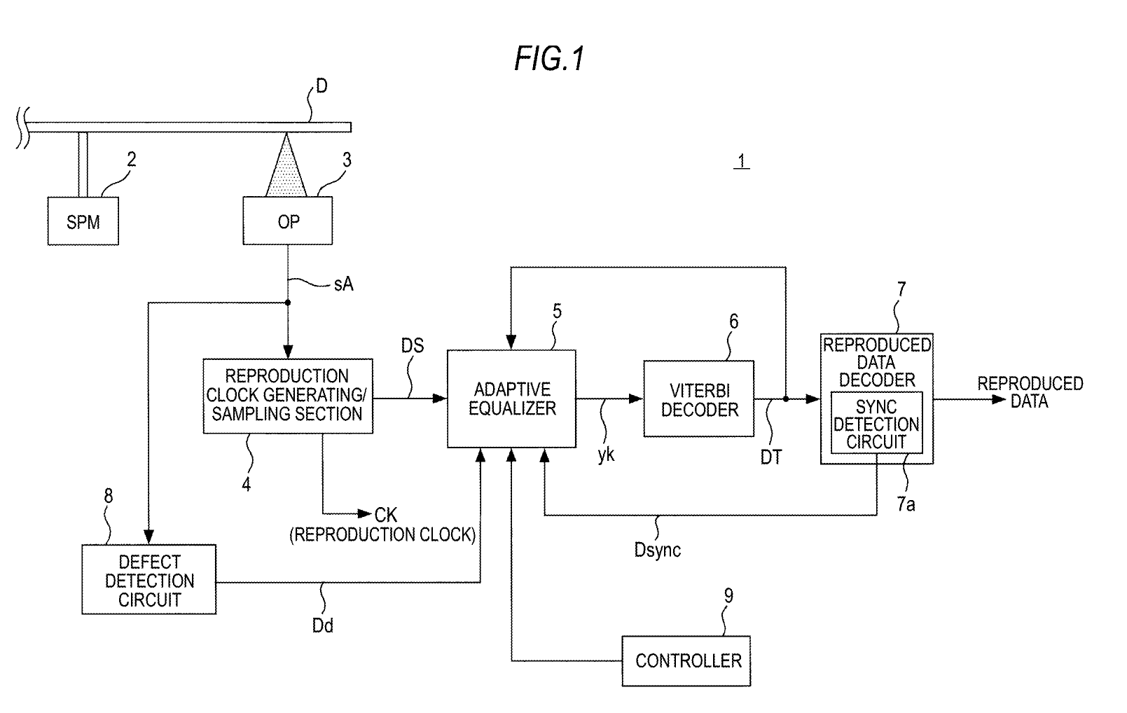

FIG. 1 shows the internal configuration of a disc driving apparatus 1 which is a reproduction apparatus according to an embodiment of the present invention.

Moreover, in FIG. 1, the configuration of a reproduction system in the disc driving apparatus 1 is mainly extracted and shown. For example, other configurations, such as various kinds of servo systems for tracking and focusing, are not shown.

In FIG. 1, an optical disc D is a disc-shaped optical recording medium. The optical recording medium refers to a recording medium in which a recorded signal is reproduced by irradiation of light. The optical disc D is driven to rotate by a spindle motor (SPM) 2 shown in FIG. 1.

An optical head (optical pickup) 3 irradiates a laser beam, which is emitted from a laser diode, onto the optical disc D through an objective lens using a predetermined optical system. In addition, the optical head 3 guides the light, which is reflected from the optical disc D, to a photodetector through a predetermined optical system and acquires an electric signal corresponding to the amount of reflected light. In addition, a reproduction signal sA (reproduced RF signal) of the recorded information or various servo error signals for tracking and focusing are generated by performing calculation processing on each light amount signal detected by the plurality of photodetectors.

The reproduction signal sA read by the optical head 3 is supplied to a reproduction clock generating/sampling section 4. The reproduction clock generating/sampling section 4 generates a reproduction clock CK in synchronization with the reproduction signal sA using a PLL (Phase Locked Loop) circuit, and performs digital sampling of the reproduction signal sA and outputs a sampling signal (digital reproduction signal) DS.

The reproduction clock CK is used as a clock of each of the necessary sections, such as an adaptive equalizer 5 or a Viterbi decoder 6 and a reproduced data decoder 7, which will be described later.

Moreover, the sampling signal DS is supplied to the adaptive equalizer 5.

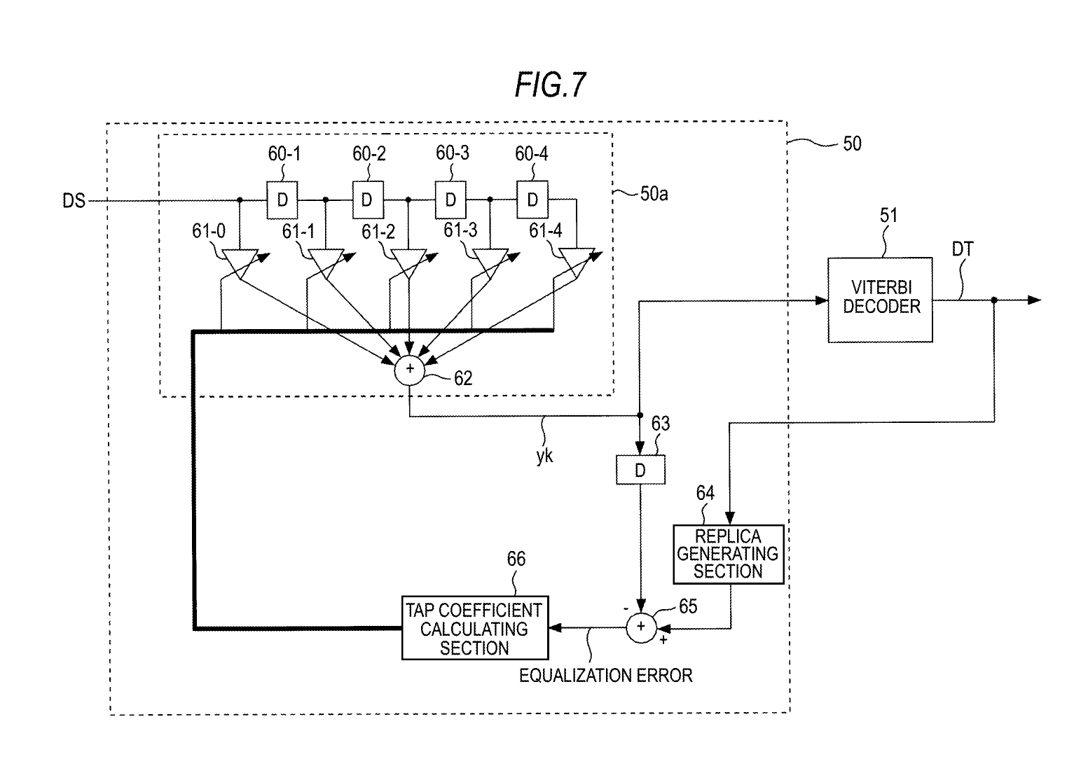

The adaptive equalizer 5 performs adaptive equalization processing so that the reproduction signal DS becomes equal to a target signal. Specifically, the adaptive equalizer 5 of the present embodiment has a configuration as an LMS TVF (Least Mean Square Transversal Filter) including an FIR (Finite Impulse Response) filter (FIR filter 5a to be described later) and a tap coefficient calculating section (tap coefficient calculating section 16 to be described later) which performs calculation processing for updating a tap coefficient using a so-called least square method, similar to the adaptive equalizer 50 shown in FIG. 7 which was described previously.

As shown in FIG. 1, the decoded data DT, which is a decoding result of the Viterbi decoder 6, is input to the adaptive equalizer 5, and equalization processing on the reproduction signal DS is performed with a target signal generated from the decoded data DT as an equalization target.

In addition, the internal configuration of the adaptive equalizer 5 in the present embodiment will be described later.

The reproduction signal DS (hereinafter, referred to as an equalization signal yk) after equalization processing of the adaptive equalizer 5 is supplied to the Viterbi decoder 6.

The Viterbi decoder 6 performs binarization of the reproduction signal DS by so-called Viterbi decoding processing. That is, the Viterbi decoder 6 checks the Euclidean distance between the equalization signal yk and the partial response of a bit series which can be assumed and outputs a bit series, by which the distance becomes the minimum, as a detection result.

The decoded data (binary data string) DT obtained by decoding processing of the Viterbi decoder 6 is supplied to the reproduced data decoder 7.

The reproduced data decoder 7 performs reproduction processing, such as demodulation processing regarding RLL (1, 7) modulation, error correction processing, and deinterleaving, on the decoded data DT and obtains the reproduced data demodulated as a result.

Moreover, a sync detection circuit 7a is provided in the reproduced data decoder 7, as shown in FIG. 1. The sync detection circuit 7a performs sync (synchronization signal) detection by detecting a predetermined data pattern included in a binary data string as the decoded data DT. A sync detection signal Dsync acquired by the sync detection circuit 7a is used for reproduction processing of the reproduced data decoder 7 and is also supplied to the adaptive equalizer 5.

In addition, a defect detection circuit 8 and a controller 9 are provided in the disc driving apparatus 1.

The defect detection circuit 8 performs defect detection after the reproduction signal sA acquired by the optical head 3 is input thereto, and outputs a defect detection signal Dd indicating a result of the defect detection. In this example, the H level section of the defect detection signal Dd indicates a defect detecting section.

As shown in FIG. 1, the defect detection signal Dd is supplied to the adaptive equalizer 5.

In addition, the controller 9 is a microcomputer including a CPU (Central Processing Unit), a ROM (Read Only Memory), a RAM (Random Access Memory), and the like. The controller 9 performs overall control of the disc driving apparatus 1 by executing control and processing according to a program stored in the ROM, for example.

In particular, the controller 9 in the present embodiment stores a tap coefficient as the initial value in a coefficient holding section 17, which is provided in the adaptive equalizer 5, at the start timing of a reproduction operation of the optical disc D. This will be described later.

### [1-2. Internal Configuration of an Adaptive Equalizer]

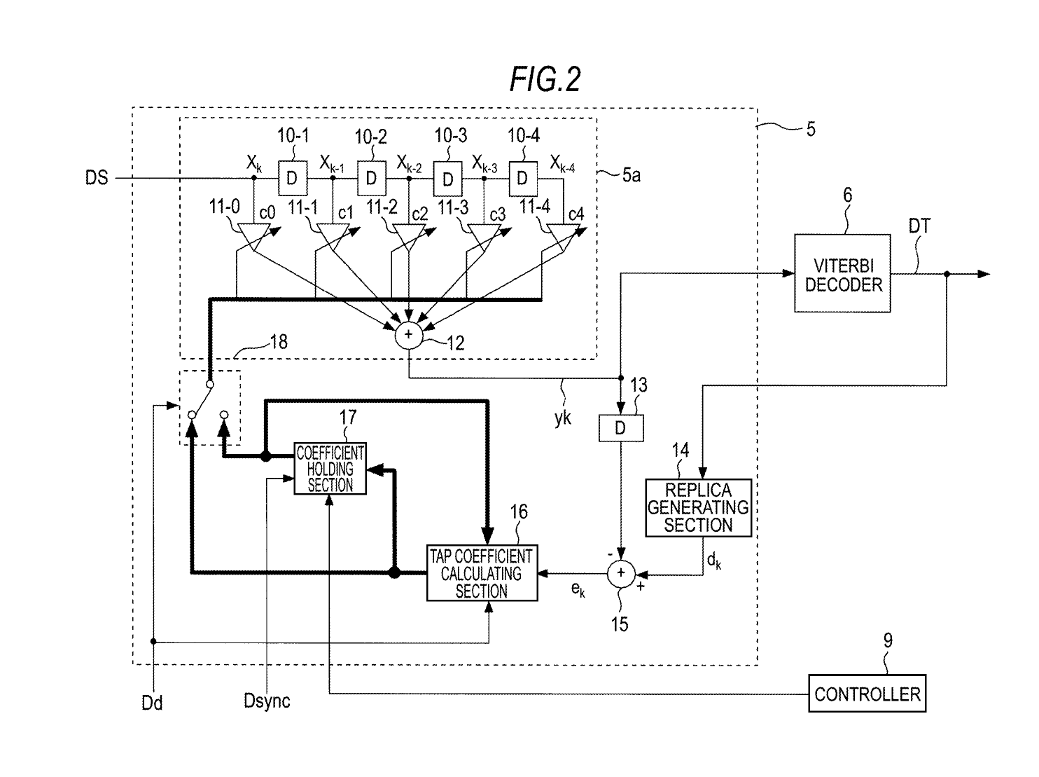

FIG. 2 shows the internal configuration of the adaptive equalizer 5 shown in FIG. 1.

In addition, the Viterbi decoder 6 and the controller 9 shown in FIG. 1 are shown in FIG. 2 together with the internal configuration of the adaptive equalizer 5.

First, the FIR filter 5a is provided in the adaptive equalizer 5. Also in this case, the FIR filter 5a is an FIR filter corresponding to “the number of taps=5”, similar to the FIR filter 50a shown in FIG. 7 which was described previously.

As shown in FIG. 2, the reproduction signal DS as an input signal is supplied to the FIR filter 5a. In addition, four delay circuits 10-1 to 10-4 are inserted in series on the input line of the reproduction signal DS, and a total of five multipliers 11 are also provided. These are a multiplier 11-0 to which the reproduction signal DS input to the delay circuit 10-1 is branch-input, a multiplier 11-1 to which the reproduction signal DS input to the delay circuit 10-2 through the delay circuit 10-1 is branch-input, a multiplier 11-2 to which the reproduction signal DS input to the delay circuit 10-3 through the delay circuit 10-2 is branch-input, a multiplier 11-3 to which the reproduction signal DS input to the delay circuit 10-4 through the delay circuit 10-3 is branch-input, and a multiplier 11-4 to which the reproduction signal DS is input through the delay circuit 10-4.

As shown in FIG. 2, outputs of the multipliers 11 (11-0 to 11-4) are added by an adder 12, and the addition result of the adder 12 is output as the equalization signal yk.

The equalization signal yk, which is an output of the FIR filter 50a, is supplied to the Viterbi decoder 6 as an output signal of the adaptive equalizer 5 and is also supplied to a delay circuit 13 provided in the adaptive equalizer 5 as shown in FIG. 2.

Similar to the delay circuit 63 shown in FIG. 7 which was described previously, the delay circuit 13 delays the equalization signal yk by the time taken for Viterbi decoding processing. The equalization signal yk which has passed through the delay circuit 13 is supplied to a subtracter 15.

In addition, a replica generating section 14 is provided in the adaptive equalizer 5. The replica generating section 14 generates a replica signal by weighting addition of a PR characteristic coefficient (for example, (1, 2, 2, 1)) set beforehand to the decoded data DT supplied from the Viterbi decoder 6. That is, a bit series as a decoding result is converted into a partial response series. As a result, a target signal as an equalization target of the adaptive equalizer 5 is acquired. A target signal as the replica signal generated by the replica generating section 14 is supplied to the subtracter 15.

The subtracter 15 calculates an equalization error by subtracting the equalization signal yk, which is supplied through the delay circuit 13, from the target signal acquired by the replica generating section 14.

The equalization error (equalization error signal) calculated by the subtracter 15 as described above is input to the tap coefficient calculating section 16.

The tap coefficient calculating section 16 calculates (updates) a tap coefficient of the multipliers 11 (11-0 to 11-4) described above using a so-called least square method (LMS).

Moreover, for clarity, the calculation for updating a tap coefficient in the LMS TVF is generally expressed by the following Expression [1].

Cₖ₊₁=Cₖ+u*Xₖ*eₖ [1]

In Expression [1], “Cₖ” is a coefficient vector. That is, Cₖ={c0ₖ, c1ₖ, . . . , c4ₖ}. “Xₖ” is a filter input signal vector. That is, Xₖ={Xₖ, Xₖ₋₁, . . . , Xₖ₋₄}. “eₖ” is an equalization error. That is, eₖ=dₖ−yₖ (yₖ is yk after delay). “u” is a step size.

In the present embodiment, in addition to the above configuration, the coefficient holding section 17 and a selector 18 are provided in the adaptive equalizer 5.

As shown in FIG. 2, the tap coefficient calculated by the tap coefficient calculating section 16 is input to the coefficient holding section 17, and the sync detection signal Dsync from the sync detection circuit 7a shown in FIG. 1 is also supplied to the coefficient holding section 17.

The coefficient holding section 17 holds (latches) the tap coefficient (that is, a tap coefficient set for the multipliers 11), which is supplied from the tap coefficient calculating section 16, at the detection timing of a sync indicated by the sync detection signal Dsync.

As shown in FIG. 2, the value held in the coefficient holding section 17 is supplied not only to the tap coefficient calculating section 16 but also to the selector 18.

The tap coefficient held in the coefficient holding section 17 is supplied to the selector 18, and the tap coefficient from the tap coefficient calculating section 16 is also supplied to the selector 18.

The selector 18 selects one of the tap coefficient from the coefficient holding section 17 and the tap coefficient from the tap coefficient calculating section 16 on the basis of the defect detection signal Dd from the defect detection circuit 8 shown in FIG. 1 and outputs it. Specifically, the selector 18 in this example is configured to select the tap coefficient from the coefficient holding section 17 only at the end timing of a defect section expressed by the defect detection signal Dd (in this example, a falling timing of the defect detection signal Dd) and to select the tap coefficient from the tap coefficient calculating section 16 in the other periods.

As shown in FIG. 2, the tap coefficient selected and output from the selector 18 is set for each of the multipliers 11-0 to 11-4.

Moreover, in this example, the defect detection signal Dd from the defect detection circuit 18 shown in FIG. 1 is supplied to the tap coefficient calculating section 16.

The tap coefficient calculating section 16 in this example is configured to start tap coefficient updating calculation processing using the value of the tap coefficient held in the coefficient holding section 17 on the basis of the defect detection signal Dd.

Specifically, the tap coefficient calculating section 16 in this case acquires the value of the tap coefficient held in the coefficient holding section 17 at the falling timing of the defect detection signal Dd (end timing of the defect section) and starts the tap coefficient updating calculation processing using the value of the acquired tap coefficient. That is, referring to Expression [1] described above, the tap coefficient updating calculation processing using the value of the tap coefficient held in the coefficient holding section 17 as the value of “Cₖ” is started.

Moreover, for clarity, the tap coefficient calculating section 16 calculates a tap coefficient for each multiplier 11, and the tap coefficient calculated individually for each multiplier 11 as described above is set for each multiplier 11.

Although simply shown in FIG. 2 for convenience of illustration, a tap coefficient corresponding to each multiplier 11 is individually output from the tap coefficient calculating section 16 and the coefficient holding section 17 and the selector 18 are inserted on the individual line for each tap coefficient in practice.

### [1-3. Explanation Regarding an Operation]

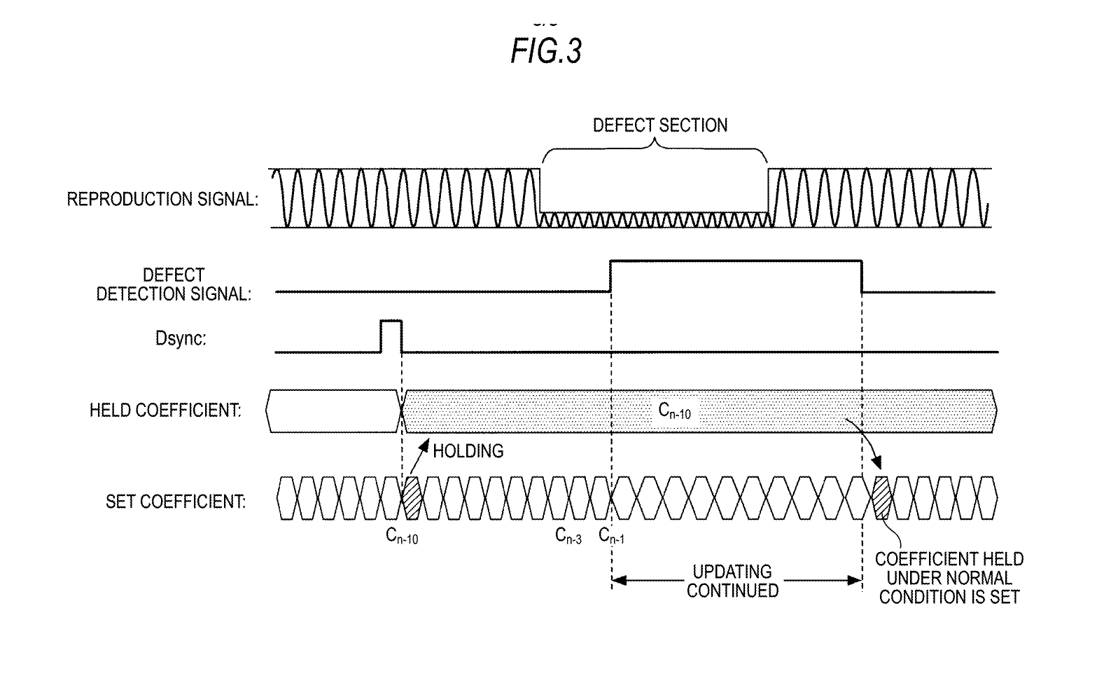

FIG. 3 is a timing chart for explaining an operation of the adaptive equalizer 5 shown in FIG. 2.

In addition, FIG. 3 shows waveforms of the reproduction signal sA, the defect detection signal Dd, and the sync detection signal Dsync and also shows transition of a tap coefficient held in the coefficient holding section 17 and transition of a tap coefficient set for the multipliers 11 which are a “held coefficient” and a “set coefficient”, respectively.

First, the coefficient holding section 17 holds the tap coefficient, which is output from the tap coefficient calculating section 16, at the detection timing of a sync indicated by the sync detection signal Dsync, as described previously.

In FIG. 3, assuming that the defect detection timing is a reference time n, the case is shown in which a sync detection timing immediately before the defect detection timing is located ten clocks before the reference time n. In this case, assuming that the set tap coefficient at the reference time n is Cₙ, the coefficient holding section 17 may be expressed as holding a tap coefficient Cₙ₋₁₀ as shown in the drawing.

It is assumed that the defect section appears after the coefficient is held by the coefficient holding section 17 as described above. Moreover, it is assumed that the end of the defect section is detected on the basis of the defect detection signal Dd. At the timing when the end of the defect section has been detected as described above, the tap coefficient calculating section 16 starts the tap coefficient updating calculation processing using the value of the tap coefficient held in the coefficient holding section 17. As a result, the updating calculation processing using the tap coefficient held under the normal condition can be started after the defect section.

Here, when “sync is detected”, it may be considered that correct input as the reproduction signal sA is performed, that is, a normal input signal is acquired. Accordingly, as a result of obtaining the above-described operation, tap coefficient updating processing using the correct tap coefficient held under the normal condition can be started immediately after the end of the defect detecting section. That is, the occurrence of lowering of the reproduction performance after defect passing, which has happened in the related art, can be effectively prevented as a result.

Here, as is apparent from FIG. 3, in the present embodiment, a tap coefficient is not held in the defect detecting section but updating of a tap coefficient continues unlike the known cases.

Thus, since updating of a tap coefficient is continuously performed in the defect detecting section, lowering of the reproduction performance in the defect detecting section can be suppressed to the minimum.

However, although the above explanation is premised on the assumption that tap coefficient holding of the coefficient holding section 17 is performed before defect detection, a case may actually occur in which a defect is detected before sync detection. That is, there may be a case where the end timing of a defect comes in a state where the coefficient holding section 17 does not hold a coefficient.

Therefore, in the present embodiment, a tap coefficient as an initial value is made to be held in the coefficient holding section 17 at the timing when the equalization processing of the adaptive equalizer 5 is started, for example, at the reproduction start timing of the optical disc D.

Specifically, the controller 9 shown in FIG. 1 makes the coefficient holding section 17 execute processing for setting a tap coefficient as the initial value, which is set beforehand, at the timing set beforehand as a timing when the equalization processing of the adaptive equalizer 5 starts, for example, at the reproduction start timing of the optical disc D.

This also makes it possible to cope with a case where a sync is not detected before defect detection.

As described above, according to the present embodiment, the tap coefficient updating calculation processing after the defect detecting state is resolved can be resumed using the correct tap coefficient obtained under the normal condition.

Accordingly, it is possible to effectively prevent the occurrence of a situation where the reproduction capability is reduced after an abnormal condition is resolved. As a result, stability in the face of an abnormal condition can be improved.

### 2. Second Embodiment

Next, a second embodiment will be described.

In the first embodiment described above, an operation of updating a tap coefficient is made to continue in the defect detecting section. In a second embodiment, however, a tap coefficient is held in the defect detecting section in the same manner as in the known examples.

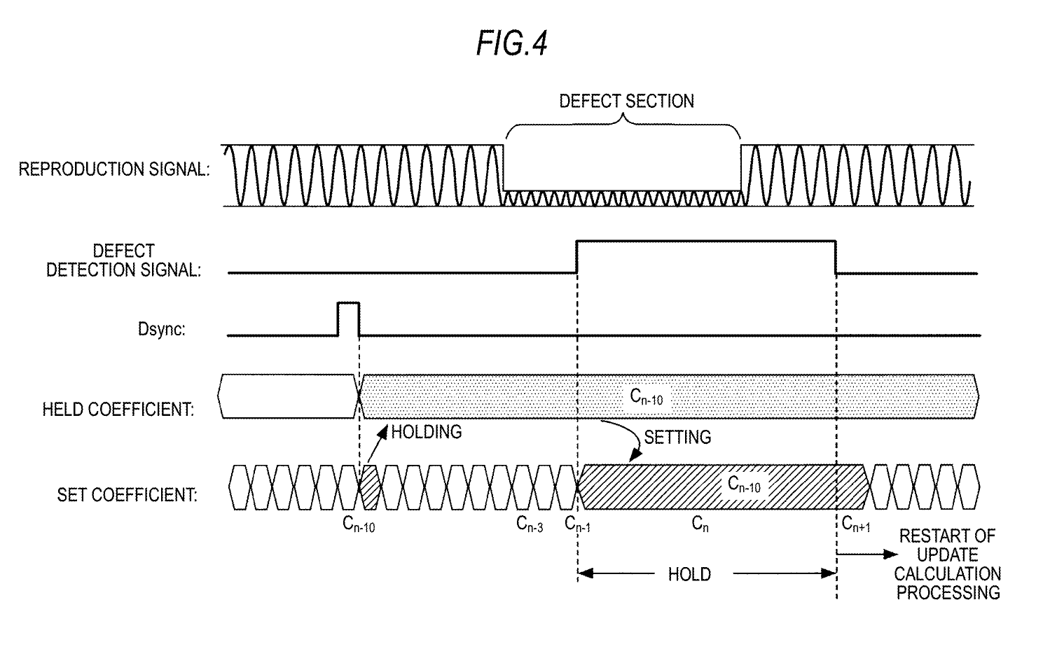

FIG. 4 is a timing chart for explaining a technique as the second embodiment in which a tap coefficient is held in a defect detecting section as described above.

In addition, FIG. 4 shows waveforms of the reproduction signal sA, the defect detection signal Dd, and the sync detection signal Dsync and also shows transition of a tap coefficient held in the coefficient holding section 17 and transition of a tap coefficient set for the multipliers 11 which are a “held coefficient” and a “set coefficient”, respectively.

As shown in FIG. 4, also in the second embodiment, the point that the coefficient holding section 17 holds a tap coefficient set for the multipliers 11 at the sync detection timing, which is indicated by the sync detection signal Dsync, is the same.

A different point in this case is that a tap coefficient held in the coefficient holding section 17 is set for the multipliers 11 and the tap coefficient updating calculation processing is stopped at the start timing of the defect section indicated by the defect detection signal Dd.

In this case, a tap coefficient set for the multipliers 11, which is a “set coefficient” in FIG. 4, is updated to a tap coefficient (Cₙ₋₁₀ in FIG. 4) held in the coefficient holding section 17 at the start detection timing of a defect and is held as the value.

Also in this case, at the defect end timing indicated by the defect detection signal Dd, tap coefficient updating calculation processing using the tap coefficient held in the coefficient holding section 17 is started.

Therefore, also in this case, the tap coefficient updating calculation processing using the correct tap coefficient held under the normal condition can be started after the end of the defect section is detected, similar to the case in the first embodiment. As a result, it is possible to prevent lowering of the reproduction capability after an abnormal condition is resolved.

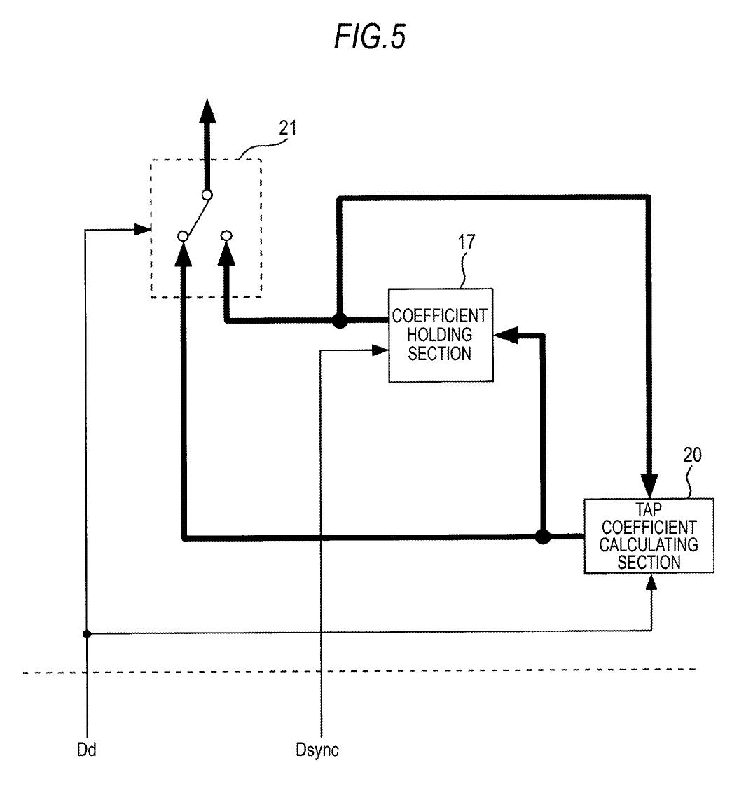

FIG. 5 is a view for explaining the configuration for realizing the technique as the second embodiment described above.

Moreover, in FIG. 5, a different part from the configuration shown in FIG. 2 is mainly extracted and shown. Since the configuration of a part which is not shown in FIG. 5 is the same as that shown in FIG. 2, the illustration is omitted. Moreover, in FIG. 5, the same elements as in FIG. 2 are denoted by the same reference numerals, and the explanation will be omitted.

Moreover, in the second embodiment, the entire configuration of the disc driving apparatus 1 is the same as that in the first embodiment. Accordingly, the explanation using FIG. 5 will be omitted.

As can be seen from the comparison with FIG. 2, the adaptive equalizer 5 in this case is different from that shown in FIG. 2 in that a tap coefficient calculating section 20 is provided instead of the tap coefficient calculating section 16 and a selector 21 is provided instead of the selector 18.

The tap coefficient calculating sections 16 and 20 are different in that the tap coefficient calculating section 16 continues the tap coefficient updating calculation processing even at the rising timing (start detection timing of the defect section) of the defect detection signal Dd, while the tap coefficient calculating section 20 stops the tap coefficient updating calculation processing at the rising timing of the defect detection signal Dd.

As can also be understood from the explanation made referring to FIG. 4, the point that the tap coefficient calculating section 20 starts tap coefficient updating calculation processing using a tap coefficient, which is held in the coefficient holding section 17, at the falling timing of the defect detection signal Dd (end detection timing of the defect section) is the same as the case of the tap coefficient calculating section 16.

In addition, the selectors 18 and 21 are different in that the selector 18 selects and outputs a tap coefficient held in the coefficient holding section 17 only at the falling timing of the defect detection signal Dd, while the selector 21 selects and outputs a tap coefficient held in the coefficient holding section 17 during a period from the rising timing to the falling timing of the defect detection signal Dd. Specifically, the selector 21 selects and outputs a tap coefficient held in the coefficient holding section 17 in a defect detecting section indicated by the defect detection signal Dd (that is, in this case, a section where the defect detection signal Dd is in an H level), and selects and outputs a tap coefficient supplied from the tap coefficient calculating section 20 in other sections.

In addition, although the case is exemplified in which a coefficient held in the defect detecting section is set as a coefficient that the coefficient holding section 17 holds, a set coefficient at the point of time of defect detection may also be set as a coefficient held in the defect detecting section similar to the case in the known example (“Cₙ₋₁” in FIG. 4).

Since there is a need for preventing the lowering of the reproduction performance after the abnormal condition is resolved, any value may be set as a tap coefficient held during detection of the abnormal condition.

### 3. Modifications

While the embodiments of the present invention has been described, the present invention is not limited to the specific examples described above.

For example, although the case where the coefficient holding section 17 holds a tap coefficient at every sync detection timing has been exemplified in the above explanation, a tap coefficient may also be held when a sync is detected a plural number of times.

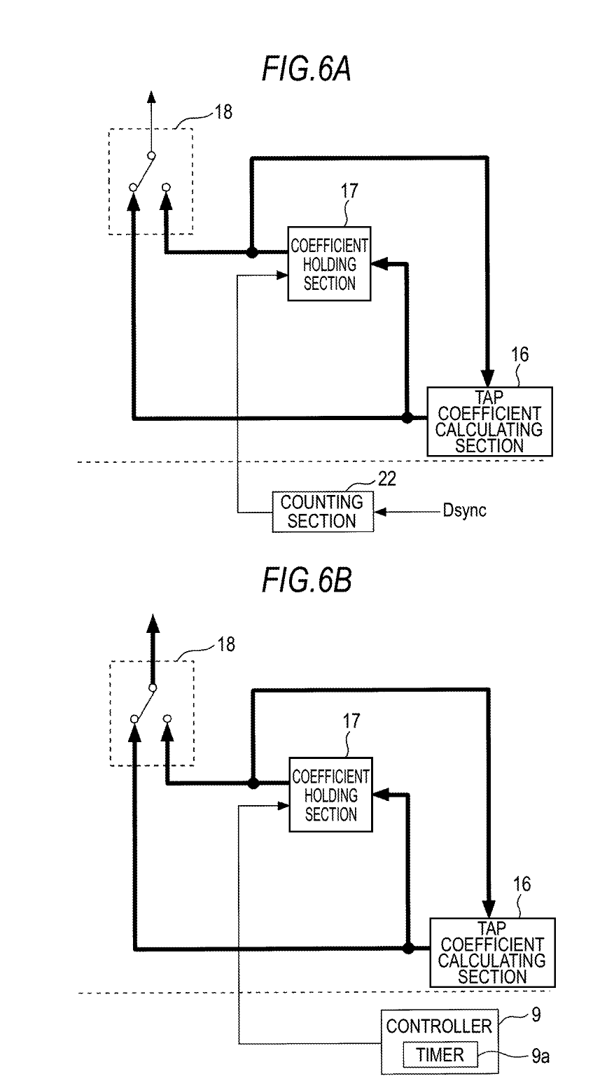

FIG. 6A is a view showing a specific example of the configuration for realizing an operation as a modification in which a tap coefficient is held when a sync is detected a plural number of times.

In this case, the sync detection signal Dsync is not input to the coefficient holding section 17 but is input to a counting section 22 as shown in the drawing. The counting section 22 counts the number of times of sync detection on the basis of the input sync detection signal Dsync and outputs a signal (holding instruction signal), which indicates that the tap coefficient is held in the coefficient holding section 17, when the number of times of sync detection reaches the predetermined number of times set beforehand. In this case, the counting section 22 is configured to reset the count value when the number of times of sync detection reaches the predetermined number of times and to output the holding instruction signal to the coefficient holding section 17 whenever the number of times of sync detection reaches the predetermined number of times.

Thus, by holding a tap coefficient with a plural number of sync detections as a trigger, it is possible to improve reliability regarding holding a correct tap coefficient corresponding to a normal reproduction signal. As a result, the stability of reproduction performance after the end of the defect detecting section can be further improved.

In addition, although FIG. 6A shows an example of the configuration when the modification is applied to the configuration shown in FIG. 2, it is needless to say that the modification can also be applied to the configuration shown in FIG. 5.

Moreover, in order to further improve reliability regarding holding a normal tap coefficient, it is possible to apply a condition of determining whether or not a sync detection interval is an interval specified in a format. Specifically, a configuration for determining whether or not a detected sync is obtained at intervals specified in a format is added, and a tap coefficient is held only at the detection timing of the sync obtained at the specified intervals.

Moreover, although the case where the coefficient holding section 17 holds a coefficient at the sync detection timing has been exemplified in the above explanation, a tap coefficient may also be held at predetermined intervals based on a timer.

FIG. 6B shows a specific example of the configuration for realizing a modification in which a tap coefficient is held at predetermined intervals as described above.

In the case shown in FIG. 6B, the controller 9 shown in FIG. 1 supplies a hold instruction signal to the coefficient holding section 17 at every predetermined interval on the basis of a built-in timer 9a. As a result, the coefficient holding section 17 can hold the value of a tap coefficient, which is set for the multipliers 11 by the tap coefficient calculating section 16, at every predetermined interval.

Also in FIG. 6B, an example of application to the configuration shown in FIG. 2 is shown. However, it is a matter of course that the modification, in which a coefficient is held at every predetermined interval, can also be applied to the case of the configuration shown in FIG. 5.

Moreover, if a coefficient is simply held every predetermined time, a tap coefficient may be held in a defect section. In the previous configuration shown in FIG. 2, a tap coefficient is also updated in the defect section. Accordingly, if a coefficient hold timing based on a timer and a defect section overlap each other, there is a possibility that an erroneous tap coefficient will be held.

Therefore, in practice, the controller 9 determines whether or not it is in a defect detecting section on the basis of the defect detection signal Dd and does not give a coefficient hold instruction to the coefficient holding section 17 if it is in the defect detecting section even if it is the coefficient hold timing based on the timer 9a. In this manner, it is possible to prevent a situation where an erroneous tap coefficient calculated by updating calculation processing in the defect section is held.

In the present invention, it is preferable that the coefficient holding section holds tap coefficients, which are set for multipliers, in a sequential manner at least at the necessary timing. Thus, by holding the tap coefficients set for the multipliers in a sequential manner at the necessary timing, it becomes possible to hold tap coefficients under the normal condition.

Moreover, although the case where the tap number of the digital filter provided in the adaptive equalizer 5 is 5 has been exemplified in the above explanation, this is only an example, and it is a matter of course that it is not limited to the exemplified value.

Moreover, although the case where the equalization filter device according to the embodiment of the present invention is applied to the reproduction apparatus of an optical recording medium has been exemplified in the above explanation, the equalization filter device according to the embodiment of the present invention may also be applied appropriately and widely to other apparatuses, such as a receiving set in a data communication system and a broadcast receiving set for receiving television broadcasting.

The present application contains subject matter related to that disclosed in Japanese Priority Patent Application JP 2009-195133 filed in the Japan Patent Office on Aug. 26, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An equalization filter device comprising:
an equalization filtering section which has a digital filter and which performs equalization processing on an input signal and updates tap coefficients, which are set for multipliers provided in the digital filter, according to an error between an equalization signal generated by the equalization processing and a target signal; and
a tap coefficient holding section which holds the tap coefficients, which are set for the multipliers, in a sequential manner at a necessary timing,
wherein the equalization filtering section starts tap coefficient updating calculation processing using the tap coefficients, which are held in the tap coefficient holding section, at an end timing of an abnormal section of the input signal specified on the basis of an abnormal detection result regarding the input signal.

2. The equalization filter device according to claim 1,
wherein a synchronization signal is inserted in the input signal, and
the tap coefficient holding section holds the tap coefficients, which are set for the multipliers, when the synchronization signal is detected from the input signal.

3. The equalization filter device according to claim 1,
wherein the equalization filtering section continues the tap coefficient updating calculation processing even after start timing of the abnormal section of the input signal specified on the basis of the abnormal detection result.

4. The equalization filter device according to claim 1,
wherein the equalization filtering section sets tap coefficients, which are held in the tap coefficient holding section, for the multipliers and stops the tap coefficient updating calculation processing at the start timing of the abnormal section of the input signal specified on the basis of the abnormal detection result.

5. The equalization filter device according to claim 2,
wherein the tap coefficient holding section holds the tap coefficients, which are set for the multipliers, when the synchronization signal is detected a plural number of times.

6. The equalization filter device according to claim 1,
wherein the tap coefficient holding section holds the tap coefficients, which are set for the multipliers, at predetermined intervals.

7. The equalization filter device according to claim 1, further comprising:
a held coefficient initializing section which holds a tap coefficient as an initial value in the tap coefficient holding section at the start timing of the equalization processing of the equalization filtering section.

8. A tap coefficient updating method of an equalization filter device which has a digital filter and which performs equalization processing on an input signal and updates tap coefficients, which are set for multipliers provided in the digital filter, according to an error between an equalization signal generated by the equalization processing and a target signal, the method comprising the steps of:
holding the tap coefficients, which are set for the multipliers, in a sequential manner at a necessary timing; and
starting tap coefficient updating calculation processing using the tap coefficients, which are held in the tap coefficient holding step, at an end timing of an abnormal section of the input signal specified on the basis of an abnormal detection result regarding the input signal.

9. A reproduction apparatus comprising:
an optical head section which acquires a reproduction signal of a signal recorded in an optical recording medium by irradiation of a laser beam onto the optical recording medium and reception of the reflected light;
an equalization filtering section which has a digital filter and which performs equalization processing on the reproduction signal and updates tap coefficients, which are set for multipliers provided in the digital filter, according to an error between an equalization signal generated by the equalization processing and a target signal;
a tap coefficient holding section which holds the tap coefficients, which are set for the multipliers, in a sequential manner at necessary timing; and
a defect detecting section which detects a defect in the reproduction signal,
wherein the equalization filtering section starts tap coefficient updating calculation processing using the tap coefficients, which are held in the tap coefficient holding section, at an end timing of a defect section of the reproduction signal specified on the basis of a defect detection result of the defect detecting section.
